(19) United States
(12) Patent Application Publication
(10) Pub. No.: US 2015/0022317 A1
(43) Pub. Date: Jan. 22, 2015

(54) SYSTEMS AND METHODS FOR UNLOCK WITH SECURITY MODE

(71) Applicant: GM GLOBAL TECHNOLOGY OPERATIONS LLC, Detroit, MI (US)

(72) Inventors: RICHARD J. LANGE, TROY, MI (US); LISA J. DODSON, ORTONVILLE, MI (US); DAVID T. PROEFKE, TROY, MI (US)

(21) Appl. No.: 13/944,527

(22) Filed: Jul. 17, 2013

(51) Int. Cl. G07C 9/00; E05B 81/54; E05B 77/48; E05B 83/00

(52) U.S. Cl. CPC G07C 9/00182; E05B 83/00; E05B 81/54; E05B 77/48; G07C 2009/00206
USPC 340/5.61

(57) ABSTRACT

Methods and apparatus are provided for controlling a plurality of locks associated with a vehicle based on a security mode. The method includes receiving a request to unlock one of the plurality of locks and receiving, from a source of data, a first mode for the operation of the plurality of locks. The method includes determining a current mode of operation based on whether an input has been received that indicates a change to a default mode of operation, and selectively outputting one or more control signals to unlock one or more of the plurality of locks based on the determining.

### TECHNICAL FIELD

The present disclosure generally relates to vehicles and more particularly relates to systems and methods for unlocking one or more doors and/or a trunk or liftgate associated with the vehicle based on a security mode.

### BACKGROUND

Typically, a vehicle can include a cabin, which can have one or more doors to gain entry to the cabin, and can include a trunk or a liftgate that can provide access to a cargo area associated with the vehicle. Generally, each of the doors and the trunk or liftgate can have a lock, which can be actuated to secure the door and trunk or liftgate to the vehicle to prevent unwanted entry into the cabin of the vehicle or the cargo area. In certain instances, depending upon the vehicle surroundings, it may be desirable to unlock one door of the vehicle or to unlock one or more doors associated with the vehicle. In addition, depending on the vehicle surroundings, it may be desirable to unlock the trunk or liftgate only, or to unlock the trunk or liftgate and each of the doors.

Accordingly, it is desirable to provide systems and methods to unlock one or more doors of the vehicle and/or the trunk or liftgate of the vehicle based on a security mode. Furthermore, other desirable features and characteristics of the present invention will become apparent from the subsequent detailed description and the appended claims, taken in conjunction with the accompanying drawings and the foregoing technical field and background.

### SUMMARY

A method is provided for controlling a plurality of locks associated with a vehicle based on a security mode. The method includes receiving a request to unlock one of the plurality of locks and receiving, from a source of data, a first mode for the operation of the plurality of locks. The method includes determining a current mode of operation based on whether an input has been received that indicates a change to a default mode of operation, and selectively outputting one or more control signals to unlock one or more of the plurality of locks based on the determining.

An apparatus is provided for a lock control system for a vehicle having a security mode. The apparatus includes a mode selector switch coupled to the vehicle that transmits a mode selector control signal based on an input and a door coupled to the body and including a lock. The apparatus includes a source of data that provides a first mode for the operation of the lock and a control module that receives the data from the source, the mode selector control signal and a request to unlock the lock. The control module outputs one or more control signals to unlock the lock according to the first mode of operation provided by the source of data or outputs one or more control signals to unlock the lock according to a default mode based on the mode selector control signal.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle that includes a door lock system and cargo lock system in accordance with various embodiments;

FIG. 2 is a dataflow diagram illustrating a lock control system of the door lock system and cargo lock system in accordance with various embodiments; and

FIG. 3 is a flowchart illustrating a control method of the lock control system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

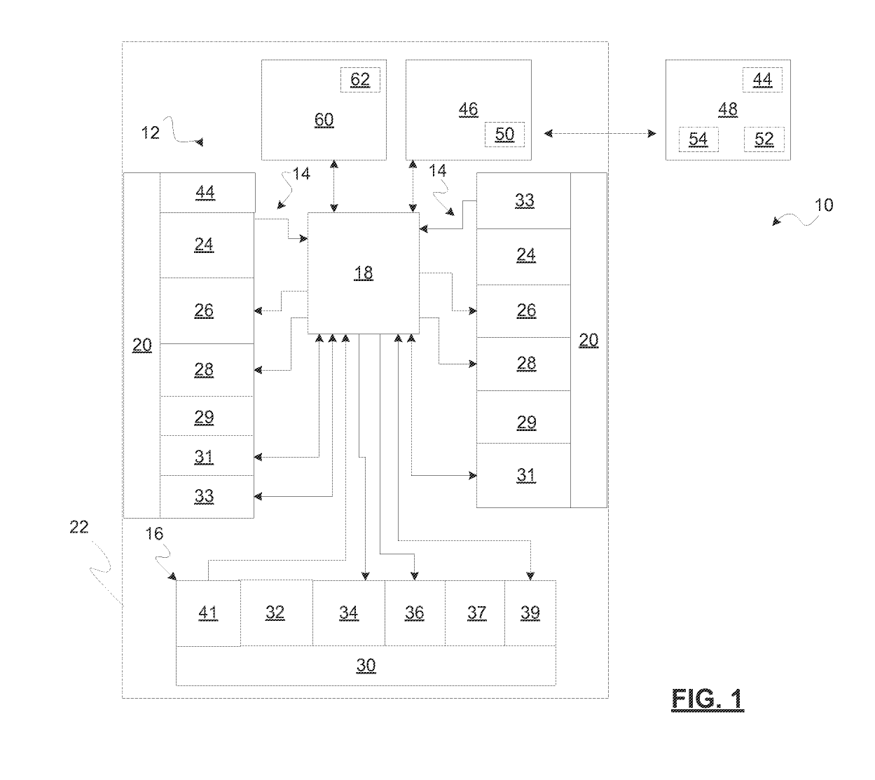

With reference to FIG. 1, a vehicle 10 is shown to include a lock system 12 in accordance with various embodiments. The lock system 12 includes one or more door lock systems 14, a cargo lock system 16, and a control module 18. As will be discussed in greater detail herein, the control module 18 of the lock system 12 can receive one or more inputs from the one or more door lock systems 14 and/or the cargo lock system 16 to control an operation of one or more locks of the lock system 12. The control module 18 controls the operation based on a lock mode. As can be appreciated, the control module 18 can alternatively be implemented as multiple control modules (not shown), one for each door lock system 14 and cargo lock system 16. For exemplary purposes, the control module 18 will be discussed as a single control module 18 that controls the multiple door lock systems 14 and the cargo lock system 16.

Generally, a door lock system 14 can be associated with one or more doors 20 of the vehicle 10. The doors 20 can be coupled to a body 22 of the vehicle 10, and can permit ingress and egress from a cabin defined by the body 22 of the vehicle 10 as well known to those skilled in the art. The doors 20 can include, but are not limited to, entry doors and cargo entry doors. For exemplary purposes, a single door lock system 14 is associated with a single door 20 of the vehicle 10. Thus, the vehicle includes multiple door lock systems 14.

Each door lock system 14 can include a lock 24, a lock actuator 26, a notification system 28, a latch 29, a latch actuator 31 and a sensor 33. The lock 24 can be any suitable locking mechanism, including, but not limited to, an electrical device or an electro-mechanical device, suitable for selectively securing (locking and unlocking) the door 20 to the body 22 to prevent access to the cabin of the vehicle 10. The lock actuator 26 can comprise any suitable lock actuation device, which can be in communication with the control module 18. For example, the lock actuator 26 can comprise a virtual lock actuator, which can serve to electronically prevent the unlocking of the door 20 based on an electric lock state recorded in the control module 18. In this example, when the electric lock state is recorded in the control module 18 as locked, the latch actuator 31 is prevented from actuating the latch 29 unless the electric lock state is changed to unlocked (based on the receipt of a signal from a remote keyless entry (RKE) system 46, for example). Thus, the lock actuator 26 need not be a separate component, but could be a state of the lock 24 associated with the control module 18. The lock actuator 26 receives signals from the control module 18 and actuates the unlocking and locking of the lock 24.

The notification system 28 can notify the operator that one or more of the locks 24 of the doors 20 are locked or unlocked. The notification system 28 can include one or more visual indicators, which can be in communication with the control module 18. In one example, a visual indicator can be coupled to each of the doors 20, however, the visual indicator could be coupled adjacent to the doors 20. The visual indicators can visually indicate whether that the lock 24 of the door 20 is locked and secured to the body 22 of the vehicle 10.

The latch 29 can be any suitable latching mechanism, including, but not limited to, an electrical device or an electro-mechanical device, suitable for selectively latching (latching and unlatching) the door 20 to the body 22 to secure the door 20 to the vehicle 10. The latch actuator 31 can comprise any suitable actuation device, which can be in communication with the control module 18, including, but not limited to an electrical switch, mechanical handle, etc. In addition, the door 20 can include more than one latch actuator 31. For example, the door 20 can include a latch actuator 31 on an exterior of the door 20, including, but not limited to an electrical switch, and can include a latch actuator 31 on an interior of the door 20, including, but not limited to a mechanical handle. The latch actuator 31 sends and receives signals from the control module 18 and actuates the unlatching and latching of the latch 29. The sensor 33 observes conditions associated with the door 20 and generates sensor signals based on the observed conditions. In one example, the sensor 33 observes if the door 20 is opened relative to the body 22. Thus, the sensor 33 includes, but is not limited to, a door ajar sensor.

The cargo lock system 16 can be associated with a cargo entry structure 30, such as, a trunk lid or a liftgate, associated with the vehicle 10. The cargo entry structure 30 can be coupled to the body 22 of the vehicle 10, and can permit access to a cargo area associated with the vehicle 10, which may or may not be separate from the passenger cabin of the vehicle 10. The cargo lock system 16 can include a cargo lock 32, a cargo lock actuator 34, a notification system 36, a cargo latch 37, a cargo latch actuator 39 and a cargo sensor 41. The cargo lock 32 can be any suitable mechanism, including, but not limited to, an electrical device or an electro-mechanical device, suitable for selectively securing (locking and unlocking) the cargo entry structure 30 to the body 22 to prevent access to the cargo area of the vehicle 10. The cargo lock actuator 34 can comprise any suitable electrical actuation device, which can be in communication with the control module 18. The cargo lock actuator 34 receives signals from the control module 18 and actuates the unlocking or locking of the cargo lock 32.

The notification system 36 can notify the operator that the cargo lock 32 of the cargo entry structure 30 is locked or unlocked. The notification system 36 can include one or more visual indicators, which can be in communication with the control module 18. In one example, a visual indicator can be coupled to the cargo entry structure 30, however, the visual indicator could be coupled adjacent to the cargo entry structure 30. The visual indicators can visually indicate whether that the cargo lock 32 of the cargo entry structure 30 is locked and secured to the body 22 of the vehicle 10.

The cargo latch 37 can be any suitable latching mechanism, including, but not limited to, an electrical device or an electro-mechanical device, suitable for selectively latching (latching and unlatching) the cargo entry structure 30 to the body 22 to secure the cargo entry structure 30 to the vehicle 10. The cargo latch actuator 39 can comprise any suitable actuation device for the cargo latch 37, which can be in communication with the control module 18, including, but not limited to an electrical switch, mechanical handle, etc. The cargo latch actuator 39 sends and receives signals from the control module 18 and actuates the unlatching and latching of the cargo latch 37. The cargo sensor 41 observes conditions associated with the cargo entry structure 30 and generates sensor signals based on the observed conditions. In one example, the cargo sensor 41 observes if the cargo entry structure 30 is opened relative to the body 22. Thus, the cargo sensor 41 includes, but is not limited to, an ajar sensor.

In various embodiments, at least one, if not more, of the door lock systems 14 or the cargo lock system 16 of the vehicle 10 includes a mode selector switch 44. For exemplary purposes, the disclosure will be discussed in the context of a single mode selector switch 44. The mode selector switch 44 can be coupled to the exterior of the vehicle 10, and in one example, can be coupled to the doors 20 or the cargo entry structure 30 of the vehicle 10. The mode selector switch 44 can be in communication with the control module 18, and can comprise any suitable user input device that can be actuated to send a signal to the control module 18. It should be noted that the one or more mode selector switches 44 need not be coupled directly to the doors 20, but could be coupled to an exterior pillar associated with the body 22 of the vehicle 10, such as the B-pillar, or any other exterior component of the vehicle 10, or component exterior to the vehicle 10 (e.g., a key fob or other device). Further, the one or more mode selector switches 44 can be coupled to an interior of the vehicle 10, such as within a passenger cabin of the vehicle 10. In addition, the one or more mode selector switches 44 can be coupled to a portion of the RKE system 46, such as a fob 48 of the RKE system 46. In this example, the mode selector switch 44 associated with the fob 48 may act as a permanent mode selector switch, such that the mode selector switch 44 on the fob 48 sets a default mode for the operation of the door lock systems 14 and the cargo lock system 16, and a mode selector switch 44 located on the vehicle 10 may act as a temporary override switch, such that the mode selector switch 44 on the vehicle 10 may temporarily change the mode of operation of the door lock systems 14 and the cargo lock system 16 from the default mode to another mode.

In various embodiments, the RKE system 46 can be used to send a signal to the control module 18 to generate signals to actuate one or more of the lock actuators 26, 34. Alternatively, the RKE system 46 can send a signal to the control module 18 to change the lock state from locked to unlocked. Generally, the RKE system 46 can include a fob 48 and a receiver 50 as known to one skilled in the art. In one example, the fob 48 can include one or more user input devices 52 and a transmitter 54. In the case of an “active” RKE system 46, the user input devices 52 can be actuated by an operator to generate a signal to lock or unlock the locks of one or more of the doors 20 and/or the cargo entry structure 30 of the vehicle 10. The signals generated by the actuation of the user input devices 52 can be transmitted by the transmitter 54 over a suitable wireless link to the receiver 50.

Alternatively, in the case of a “passive” RKE system 46, the transmitter 54 can transmit a signal to the receiver 50 when the fob 48 has left or has entered a predetermined zone associated with the vehicle 10. For example, the transmitter 54 can transmit a signal when the fob 48 is about or within fifteen feet from the vehicle 10. The receiver 50 can receive the signals from the transmitter 54 of the fob 48. The receiver 50 can be in communication with the control module 18 to provide the signals received from the transmitter 54 to the control module 18.

As will be discussed in greater detail below, the control module 18 can control the operation of the door lock actuators 26, the cargo lock actuator 34, the latch actuators 31 and/or the cargo latch actuator 39 based on input received from the RKE system 46, the mode selector switch 44, the latch actuators 31 and/or the cargo latch actuator 39. In particular, when the RKE system 46 generates an unlock request and a request to unlatch one or more latches 29 or cargo latch 37 has been received by a respective one of the latch actuators 31 and/or cargo latch actuator 39, the control module 18 generates one or more signals to the door lock systems 14 and/or the cargo lock system 16 to unlock one or more doors 20 or the cargo entry structure 30 based on a current mode of operation of the lock system 12. The control module 18 can change the current mode of operation from a first mode to a second mode based on signals received from the mode selector switch 44. The first mode can be, for example, but is not limited to, a “Convenience Mode” that unlocks all locks, a “Security Mode” that unlocks only one lock, or a user-configured mode. The second mode can be associated with the first mode as an alternative mode and can likewise include, the “Convenience Mode,” the “Security Mode,” or a user-configured mode. In various embodiments, the control module 18 changes the current mode of operation of the lock system from the first mode to the second mode based on the association.

In various embodiments, the modes and/or the associations can be configured by a user. In order to configure the modes and/or the associations, the vehicle 10 includes a display device 60. The display device 60 can be in communication with the control module 18 and can provide visual information to the driver and/or other users of the vehicle 10. In one example, the display device 60 can be implemented as a flat panel display in an instrument panel or console of the vehicle 10. Those skilled in the art may realize other techniques to implement the display device 60 in the vehicle 10.

The display device 60 includes a user input device 62, which can receive inputs from the user to configure modes of operation of the lock system 12. The user input device 62 may be implemented as a keypad (not separately shown), a microphone (not separately shown), a touchscreen layer associated with the display device 60, or other suitable device to receive data and/or commands from the user. Of course, multiple input devices 62 can also be utilized. In addition, the user input device 62 receives inputs from the user to set a mode of operation of the lock system 12, such as the “Convenience Mode,” the “Security Mode,” or the user-configured mode.

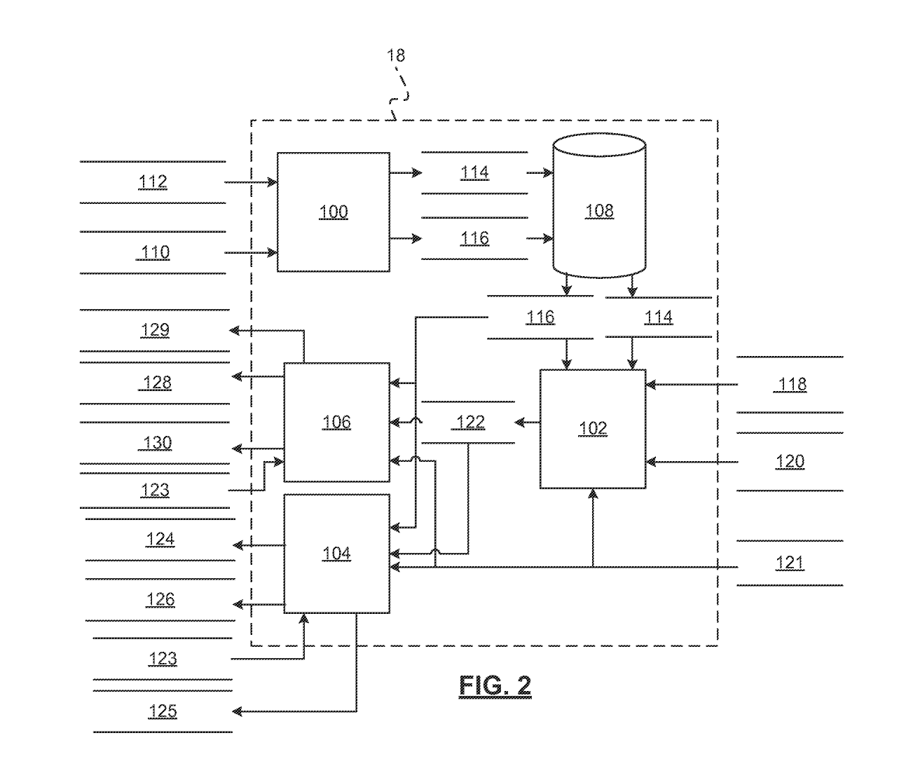

Referring now to FIG. 2 and with continued reference to FIG. 1, a dataflow diagram illustrates various embodiments of the control module 18 of the lock system 12. Various embodiments of the control module 18 according to the present disclosure can include any number of sub-modules embedded within the control module 18. As can be appreciated, the sub-modules shown in FIG. 2 can be combined and/or further partitioned to similarly generate control signals to one or more of the door lock systems 14 and the cargo lock system 16 based on a current mode. Inputs to the control module 18 may be sensed from the vehicle 10 (FIG. 1), received from other control modules (not shown) within the vehicle 10, and/or determined/modeled by other sub-modules (not shown) within the control module 18. In various embodiments, the control module 18 can include a user interface (UI) control module 100, a mode selector module 102, a door lock control module 104, a cargo lock control module 106, and a mode datastore 108.

The mode datastore 108 stores the various modes of operation and the association of the modes of operation. In various embodiments, one or more of the modes of operation are predefined (e.g., factory set) modes of operation; and one or more of the modes of operation are user-configured. As can be appreciated, the mode datastore 108 can be any non-volatile memory type that stores the information across key cycles.

The UI control module 100 generates user interface data 110 that may be used by the display device 60 to display a user interface that may include a configuration menu for configuring various mode information. For example, the configuration menu can comprise selectable items and/or text input items for configuring the various modes and the doors 20 or cargo entry structure 30 to be associated with the modes (e.g., a list of the available modes, such as the “Security Mode” and the “Convenience Mode” that are associated with a predefined set of doors 20 or cargo entry structure 30 to be unlocked during operation of that mode). In another example the configuration menu can comprise selectable items and/or text input items for configuring associations between the modes (e.g., associating the “Security Mode” as an alternative to the “Convenience Mode”, etc.). In still another example, the configuration menu can further comprise selectable items and/or text input items for configuring a desired default mode of operation.

The UI control module 100 can receive as input user input data 112 based on a user's interaction with the user interface. The user input data 112 can comprise a desired default mode 114 for the operation of the lock system 12, and/or can comprise mode data 116 that defines a particular mode to indicate which doors 20 or cargo entry structure 30 to be unlocked during the particular mode, and/or an association of the particular mode to another mode. The UI control module 100 stores the user input data 112 as a default mode 114 and mode data 116 in the mode datastore 108.

The mode selector module 102 can receive as input mode switch data 118 for example, from the mode selector switch 44 (e.g., indicating whether or not the mode selector switch 44 has been activated), and an unlock request 120 from the RKE system 46 (e.g., either the fob 48 is within range in a “passive” RKE system or the user input device 52 was selected in an “active” RKE system). The mode selector module 102 can also receive an unlatch request 121. The unlatch request 121 is received from the latch actuator 31 and/or the cargo latch actuator 39. The unlatch request 121 comprises a request to open the door 20 or cargo entry structure 30, which is received from a respective one of the latch actuator 31 and/or the cargo latch actuator 39. It should be noted that the unlock request 120 can be received from other modules associated with the vehicle 10, and/or can be received from the sensors 33, 41 associated with one or more of the doors 20 and cargo entry structure 30. It should be noted that the unlatch request 121 can be received from other modules associated with the vehicle 10.

When the unlock request 120 and unlatch request 121 is received, the mode selector module 102 retrieves from the mode datastore 108, the default mode 114, and the mode data 116. Based on the default mode 114 and the mode switch data 118 (e.g., whether or not the mode switch has been activated), the mode selector module 102 sets a current mode 122 for use by door lock control module 104 and/or the cargo lock control module 106. In one example, if the mode switch data 118 indicates that an input has not been received to the mode selector switch 44, the mode selector module 102 sets the current mode 122 to indicate the default mode 114. In another example, if the mode switch data 118 indicates that an input has been received to the mode selector switch 44, the mode selector module 102 sets the current mode 122 to indicate the mode that is associated with the selected default mode 114 as the alternative mode, depending upon the association from the mode data 116. In this regard, input received from the mode selector switch 44 can be used to temporarily operate the lock system 12 (FIG. 1) in a mode other than the default mode.

The door lock control module 104 receives as input the current mode 122, fob data 123 and unlatch request 121. Based on the current mode 122, fob data 123 and unlatch request 121, the door lock control module 104 generates one or more lock control signals 124, one or more latch control signals 125 and/or one or more lock notification signals 126 to the door lock systems 14. For example, the door lock control module 104 retrieves the mode data 116 associated with the current mode 122 from the mode datastore 108 and generates the lock control signals 124 to the lock actuators 26 based on the selected doors of the mode data 116 if the fob data 123 indicates that the fob 48 is within range in a “passive” RKE system or the user input device 52 was selected in an “active” RKE system and the unlatch request 121 is received. The lock control signals 124 can be generated to the lock actuators 26 to actuate and unlock the respective lock such that the door 20 is no longer locked to the body 22 of the vehicle 10. The door lock control module 104 also generates the latch control signals 125 to the latch actuators 31 based on the unlatch request(s) 121 received. The latch control signals 125 are generated to the latch actuators 31 to actuate and unlatch the respective latch 29 such that the door 20 is no longer secured to the body 22 of the vehicle 10.

In another example, the door lock control module 104 determines which doors are locked or unlocked based on the mode data 116 and/or the lock control signals 124 and can generate the lock notification signals 126 to activate the notification system 28 to indicate that one or more of the doors 20 is locked or unlocked to the body 22 of the vehicle 10. For example, the lock notification signals 126 can comprise data to illuminate one or more visual indicators in a color to denote that one or more of the doors 20 is locked, such as red, and can comprise data to illuminate one or more visual indicators associated with a respective one of the doors 20 in a different color to denote that one or more of the doors 20 is unlocked, such as green. It should be noted that this example is merely exemplary, as the notification system 28 could be turned off upon unlocking of a respective door 20.

It should be noted that while the above example involved receipt of an unlatch request from an exterior of the vehicle 10, the door lock control module 104 can also generate lock control signals 124 based on the signals from the sensor 33. In this example, upon receipt of the signals from the sensor 33, which indicate that the door 20 has moved from a closed position relative to the body 22 to an opened/ajar position, the door lock control module 104 generates lock control signals 124 to unlock the lock 24 associated with the respective door 20 from which the signals from the sensor 33 are received.

The cargo lock control module 106 receives as input the current mode 122, the fob data 123 and the unlatch request 121. Based on the current mode 122, the fob data 123 and the unlatch request 121, the cargo lock control module 106 similarly generates one or more lock control signals 128, latch control signals 129 and/or one more lock notification signals 130 to the cargo lock system 16. For example, the cargo lock control module 106 retrieves the mode data 116 associated with the current mode 122 from the mode datastore 108 and generates the lock control signals 128 to the lock actuator 34 based on the selected cargo entry structure 30 of the mode data 116 if the fob data 123 indicates that the fob 48 is within range in a “passive” RKE system or the user input device 52 was selected in an “active” RKE system and the unlatch request 121 is received. The control signals 128 are generated to the lock actuator 34 to actuate and unlock the lock such that the cargo entry structure 30 is no longer locked to the body 22 of the vehicle 10. The cargo lock control module 106 also generates the latch control signals 129 to the latch actuator 39 based on the unlatch request(s) 121 received. The latch control signals 129 are generated to the latch actuator 39 to actuate and unlatch the cargo latch 37 such that the cargo entry structure 30 is no longer secured to the body 22 of the vehicle 10.

In another example, the cargo lock control module 106 determines if the cargo entry structure 30 is locked or unlocked based on the mode data 116 and/or the control signals 128 and can generate the lock notification signals 130 to activate the notification system 36 to indicate that the cargo access structure is locked or unlocked to the body 22 of the vehicle 10. For example, the lock notification signals 130 can comprise data to illuminate one or more visual indicators in a color to denote that cargo access structure is locked, such as red, and can comprise data to illuminate one or more visual indicators associated in a different color to denote that the cargo access structure is unlocked, such as green. It should be noted that this example is merely exemplary, as the notification system 36 could be turned off upon unlocking of the cargo entry structure 30.

It should be noted that in the “Security Mode,” a single door 20 or cargo entry structure 30 is unlocked upon receipt of an unlock request 120 and unlatch request 121, but the lock control signals 124, 128 can be generated when the door 20 or cargo entry structure 30 is unlatched, at a period of time t after the door 20 or cargo entry structure 30 is opened based on signals from the sensors 33, 41 or when the door 20 or cargo entry structure 30 is moved from an open position to a closed position relative to the body 22, based on signals from the sensors 33, 41.

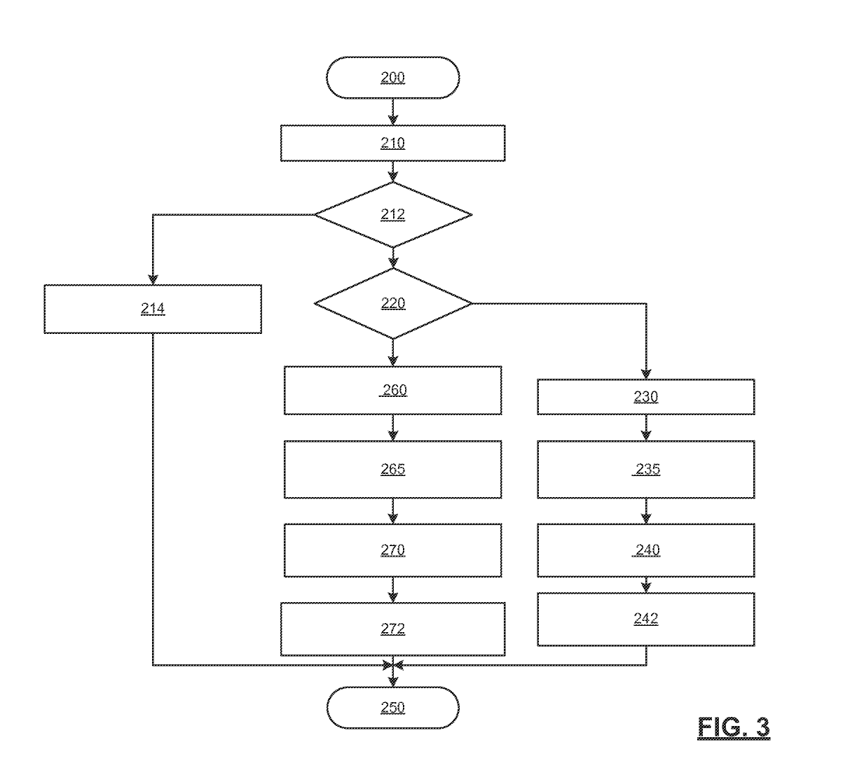

Referring now to FIG. 3, and with continued reference to FIGS. 1 and 2, a flowchart illustrates a control method that can be performed by the control module 18 accordance with the present disclosure. As can be appreciated in light of the disclosure, the order of operation within the method is not limited to the sequential execution as illustrated in FIG. 3, but may be performed in one or more varying orders as applicable and in accordance with the present disclosure. As can further be appreciated, one or more steps of the method may be added or removed without altering the spirit of the method.

The method may begin at 200. The unlatch request 121 is received from the latch actuator 31 and/or cargo latch actuator 39 at 210. At 212, the method determines if an unlock request 120 is received from the RKE system 46 at 210. If the unlock request 120 is received, the method goes to 220. Otherwise, at 214, the lock notification signals 126, 130 are generated to the notification systems 28, 36. Then, the method ends at 250.

The mode switch data 118 from the mode selector switch 44 is evaluated at 220. If the mode switch data 118 indicates that the mode selector switch 44 has not been activated at 220, the current mode 122 is set to the default mode 114 at 230. The lock notification signals 126, 130 are generated to the notification systems 28, 36 at 235. The lock control signals 124, 128 are selectively generated to one or more lock actuators 26, 34 based on the mode data 116 at 240. The latch control signals 125, 129 are selectively generated to one or more latch actuators 31, 39 based on the unlatch request 121 at 242. Thereafter, the method may end at 250.

If, however, the mode switch data 118 indicates that the mode selector switch 44 has been activated at 220, the current mode is set to the mode associated with the default mode 114 based on the mode data 116 at 260. The lock notification signals 126, 130 are generated to the notification systems 28, 36 at 265. The lock control signals 124, 128 are selectively generated to one or more lock actuators 26, 34 based on the mode data 116 at 270. The latch control signals 125, 129 are selectively generated to one or more latch actuators 31, 39 based on the unlatch request 121 at 272. Thereafter, the method may end at 250.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

What is claimed is:

1. A method of controlling a plurality of locks associated with a vehicle based on a security mode, comprising:
receiving a request to unlock one of the plurality of locks;
receiving, from a source of data, a first mode for the operation of the plurality of locks;
determining a current mode of operation based on whether an input has been received that indicates a change to a default mode of operation; and
selectively outputting one or more control signals to unlock one or more of the plurality of locks based on the determining.

2. The method of claim 1, further comprising:
determining if a fob of a remote keyless entry system is within an acceptable range of the vehicle prior to selectively outputting the one or more control signals.

3. The method of claim 1, wherein determining the current mode of operation further comprises:
determining if mode switch data has been received from a mode selector switch.

4. The method of claim 1, wherein if the current mode of operation is the first mode and each of the plurality of locks is associated with one of a plurality of doors, selectively outputting further comprises:
selectively outputting one or more control signals to unlock all of the plurality of locks based on receipt of an unlatch request for a latch associated with one of the plurality of doors.

5. The method of claim 1, wherein if the current mode of operation is the default mode and each of the plurality of locks is associated with one of a plurality of doors, selectively outputting further comprises:
selectively outputting one or more control signals to unlock one of the plurality of locks based on receipt of an unlatch request for a latch associated with one of the plurality of doors.

6. The method of claim 1, wherein the source of data is user input data and receiving, from the source of data further comprises:
receiving user input data that selects the first mode for operation of the plurality of locks.

7. A lock control system for a vehicle having a security mode, comprising:
a mode selector switch coupled to the vehicle that transmits a mode selector control signal based on an input;
a door coupled to the body and including a lock;
a source of data that provides a first mode for the operation of the lock; and
a control module that receives the data from the source, the mode selector control signal and a request to unlock the lock, and the control module:
outputs one or more control signals to unlock the lock according to the first mode of operation provided by the source of data; or
outputs one or more control signals to unlock the lock according to a default mode based on the mode selector control signal.

8. The system of claim 7, wherein the source of data is user input received from at least one user input device associated with the vehicle.

9. The system of claim 7, further comprising:
a keyless entry system that includes a fob in communication with the control module, and the control module outputs the one or more control signals based on a proximity of the fob to the vehicle.

10. The system of claim 7, wherein the first mode is a convenience mode, and the vehicle comprises a plurality of doors that each include a respective lock, and in the first mode, the control module outputs the one or more control signals to unlock each of the locks of the plurality of doors based on an unlatch request for a latch associated with one of the plurality of doors.

11. The system of claim 10, wherein the default mode is a security mode, and in the default mode, the control module outputs the one or more control signals to unlock only the lock of the one of the plurality of doors based on an unlatch request for a latch associated with the one of the plurality of doors.

12. The system of claim 10, further comprising:
a cargo entry structure coupled to the body of the vehicle to provide entry to a cargo area including a cargo lock that is in communication with the control module such that the control module outputs a cargo control signal to unlock the cargo lock based on the door unlock request in the first mode.

13. The system of claim 12, wherein the control module receives a cargo unlock request for the cargo entry structure and outputs the cargo control signal to unlock only the cargo lock based on the cargo unlock request in the default mode.

14. A vehicle, comprising:
a body including a plurality of doors, each of the plurality of doors having a lock and a latch;
a mode selector switch coupled to the vehicle that transmits a mode selector control signal based on an input; and
a control module that receives the mode selector control signal, a request to unlock one of the locks of a respective one of the plurality of doors and a request to unlatch one of the latches of a respective one of the plurality of doors, and based on the mode selector control signal, the request to unlock the one of locks the plurality of doors and the request to unlatch one of the latches of the plurality of doors, the control module:
outputs one or more control signals to unlock each of the locks of the plurality of doors; or
outputs one or more control signals to unlock only the one lock of the respective one of the plurality of doors.

15. The vehicle of claim 14, further comprising:
a source of user input data that provides at least a first mode for the operation of the locks of the plurality of doors; and
the control module outputs the control signals based on the user input data, the mode selector control signal and the unlatch request for the latch of the respective one of the plurality of doors.

16. The vehicle of claim 15, wherein the control module determines a current mode of operation based on the mode selector control signal and outputs the control signals to unlock each lock of the plurality of doors if the current mode of operation is the first mode and the control module outputs the control signals to unlock only one lock of the respective one of the plurality of doors in a default mode.

17. The vehicle of claim 16, wherein the default mode is determined based on input to the mode selector switch.

18. The vehicle of claim 14, further comprising:
a remote keyless entry system including a fob that transmits a signal to a receiver associated with the vehicle when the fob is within a predefined range of the vehicle; and
the control module outputs the one or more control signals based on whether the fob is within a predefined range of the vehicle.

19. The vehicle of claim 17, further comprising:
a cargo entry structure that provides entry to a cargo area of the vehicle, the cargo entry structure having a cargo lock operable to lock or unlock the cargo entry structure relative to the body,
wherein the control module outputs one or more control signals to unlock the cargo lock based on the current mode of operation.

20. The vehicle of claim 19, wherein in the first mode, the control module outputs the one or more control signals to unlock the cargo lock.
